(19) United States
(12) Patent Application Publication
(10) Pub. No.: US 2007/0038947 A1
(43) Pub. Date: Feb. 15, 2007

(54) Method and device for generation of a parametric model associated with a 3D geometry

(75) Inventors: Claus Brandl, Pibrac (FR); Sylvain Souche, Agen (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: AIRBUS, Blagnac (FR)

(21) Appl. No.: 11/436,589

(22) Filed: May 19, 2006

Related U.S. Application Data
(60) Provisional application No. 60/698,475, filed on Jul. 13, 2005.

(30) Foreign Application Priority Data
May 19, 2005 (FR) 0505029

(51) Int. Cl. G06F 3/00

(52) U.S. Cl. 715/762; 715/853; 715/866

(57) ABSTRACT

A device for generation of a parametric model associated with a 3D geometry includes a converter capable of converting a specifications tree into a graphical user interface in which, for at least one active element of the tree, there is associated a dialog box including at least one field associated with at least one control parameter of the active element. The adjustment of the control parameter can be modifiable by the user with the help of a parameter editor, each adjustment of the control parameter being displayed in the corresponding field of the dialog box and automatically bringing about the change of the adjustment of the control parameter of the corresponding active element in the specifications tree.

### CROSS-REFERENCE TO RELATED APPLICATIONS

This document claims priority to French Application Number 05 05029, filed May 19, 2005 and U.S. Provisional Application No. 60/698,475, filed Jul. 13, 2005, the entire contents of which are hereby incorporated by reference.

### BACKGROUND OF THE INVENTION

1. Field of the Invention

The present invention relates to generation of a parametric model associated with a 3D geometry of a component or of an assembly of components.

2. Discussion of Background

It is applicable in modeling of a geometry (Computer Assisted Design, CAD), in digital control programs for machine tools (Computer Assisted Manufacture, CAM), in computer assisted engineering programs and in data management software programs.

In general, the generation of a parametric model associated with a 3D geometry consists in defining a component directly in its final configuration, an example being an aircraft wing assembled with the fuselage.

In practice, such a final definition is integrated into an optimization loop, in the course of which the three key steps of definition, analysis and modification are repeated a plurality of times.

The essential advantage of CAD software is to permit partial or total integration of these three steps into a single and unique working environment, the transition from one step to the next taking place in almost transparent manner.

Referring now to FIG. 1, there is shown the working environment of a CAD software program such as that known as Catia, developed by Dassault Systèmes of France and commercialized by IBM. The working environment such as displayed on a computer screen comprises primarily a specifications tree 2 and a graphical zone 4. The working environment is supplemented by a menu bar 6, a standard toolbar 8, a dialog zone 10, a workbench 12 comprising a contextual tool bar depending on the active workshop, a compass 14 permitting orientation of the current view, an icon 16 representing the active workshop and a specific or application toolbar 18.

Specifications tree 2 is a structured graphical representation of the model being constructed, in this case an aircraft. In the example of FIG. 1, it is apparent that the active element designated as Product 1 is being processed, that the product comprises five principal members designated individually as “environment” 20A, “fuselage.1” 20B, “wing” 20C, “symmetry wing” 20D and “tail” 20E, and that a principal member is composed of applications 40 and control parameters 30.

The tree of the model is expanded by new items as the definition of the component proceeds.

Selection of an element can be accomplished equally well in either graphical zone 4 or in specifications tree 2. The specifications tree permits activation of a contextual menu for the designated object.

Each element of specifications tree 2 can comprise control parameters 30 and relations (not illustrated) with which the geometry of the solid or solids can be influenced via the definition of the functions present in the specifications tree.

The use of such a CAD software program therefore makes it possible to employ a digital mockup and jointly to define the product and certain processes associated therewith.

Most often, the definition of a 3D geometric model is the object of several workgroups, generally organized in different places, most often transnational. As a result, there exists an urgent need for easy and simple exchange of parametric information.

In practice, parameterization is directly permitted by the native functionalities of the software tools, especially “CATIA”. It is not necessary to recompile an application in order to modify the parameter values of a model. If suffices to use a standard function of the software in order to modify the parameter. Nevertheless, the software tools present the model in a structural organization associated with the construction history, or in the form of a dependence tree.

As it happens, such a representation is relatively far removed from the functional approach of the specialized problem related to the design of the parametric model.

It is therefore relatively difficult for a non-specialist user of the software to find a parameter easily if he does not know the result that he hopes to achieve.

### SUMMARY OF THE INVENTION

The present invention provides a solution to precisely this problem.

Thus it is intended to present the non-specialist user with a structured parameter editor in a functional approach close to the specialized problem associated with the design of the component, in order to obtain a simplified interface for modifying the parameters without the need to modify the source code.

It relates to a device for generation of a 3D geometric model of a component or of an assembly of components, the said model being represented graphically on a computer screen in the form of a specifications tree comprising at least one element defined by at least one control parameter.

According to a general definition of the invention, the generation device comprises a converter capable of converting the said specifications tree into a graphical user interface in which, for at least one active element of the said tree, there is associated a dialog box comprising at least one field associated with at least one control parameter of the said active element, the adjustment of the said control parameter being modifiable by the user with the help of a parameter editor, each adjustment of the said control parameter being displayed in the corresponding field of the dialog box and automatically bringing about the change of the adjustment of the control parameter of the corresponding active element in the specifications tree.

Thus, by virtue of the dialog box according to the invention, a user can modify the values of the parameterizable fields of an active element easily and directly, without being an information specialist in CAD software. In addition, the modification of the parameters via the dialog box brings about the corresponding modification in the specifications tree. From this there results, for a non-specialist user, great ease and simplicity of access to and modification of the control parameters of an active element of a specifications tree of a CAD software program. In addition, the modification of the parametric architecture by virtue of the invention does not necessitate modification of the source code.

According to one embodiment, the graphical interface additionally comprises a graphical window containing the geometry of the corresponding active element, the adjustment of the said parameter being displayed visually in the said graphical window.

Thus the control parameters generally defined by the specialist in CAD software and considered as interesting by the non-specialist user can be directly viewed and modified on the graphical interface and/or the dialog box according to the invention.

In practice, each element of the specifications tree belongs to the group formed by terminal nodes and non-terminal nodes.

For example, a display function of the graphical user window type and a parameter editor are associated with each terminal node.

Analogously, a parameter editor and a plurality of tabs are associated with each non-terminal node, a sub-node being associated with each tab.

For example, a graphical window is associated with at least certain tabs.

According to another embodiment, the parameter editor is additionally a script editor, in which the script language is, for example, a markup language of the XML type.

According to yet another embodiment, the generation device additionally comprises a communication device capable of remote exchange of values of parameterizable fields for the purpose of making it possible to work in collaboration remotely together with other users.

The present invention also has as an object a method for generation of a parametric model associated with a 3D geometry of a component or of an assembly of components, the said model being represented graphically on a computer screen in the form of a specifications tree comprising at least one element defined by at least one control parameter.

According to another aspect of the invention, the method comprises the following steps:

transforming the said specifications tree into a graphical user interface in which, for at least one active element of the said tree, there is associated a dialog box comprising at least one field associated with at least one control parameter of the said active element,

modifying the adjustment of the said control parameter by the user with the help of a parameter editor,

displaying each adjustment of the said control parameter in the corresponding field of the dialog box, and

automatically changing the adjustment of the control parameter of the corresponding active element in the specifications tree.

According to one embodiment, the method additionally comprises the step in which the adjustment of the said parameter is displayed visually in a graphical window.

The present invention also has as an object an information medium that can be read by an information-processing system, characterized in that it is composed of instructions of an information-processing program permitting the use of the generation method cited in the foregoing, when this program is loaded and run by an information-processing system.

The present invention also has as an object a removable information medium that can be read partly or totally by an information-processing system, characterized in that it is composed of instructions of an information-processing program permitting the use of the generation method cited in the foregoing, when this program is loaded and run by an information-processing system.

Finally, the present invention has as an object a computer program stored on an information medium, the said program being composed of instructions permitting the use of a generation method cited in the foregoing, when this program is loaded and run by an information-processing system.

### BRIEF DESCRIPTION OF THE DRAWINGS

Other characteristics and advantages of the invention will become apparent in the light of the detailed description hereinafter and of the attached drawings, wherein:

FIG. 1, already described, schematically represents the working environment of a prior art CAD software program;

FIG. 2 schematically represents the physical resources of a computer capable of implementing the invention;

FIG. 3 schematically represents the working environment of FIG. 1, on which there is overlaid a display of the dialog box according to the invention following a request by the user;

FIG. 4 schematically represents the dialog box of FIG. 3 in isolated manner;

FIG. 5 schematically represents the change, with the help of the dialog box according to the invention, of the value of the adjustment of a parameter compared with that indicated with reference to FIG. 4; and

FIG. 6 schematically represents the effect, in the specifications tree, of the change of the adjustment of the parameter described with reference to FIG. 5 compared with the tree of FIG. 1 according to the invention.

### DETAILED DESCRIPTION OF THE PREFERRED EMBODIMENTS

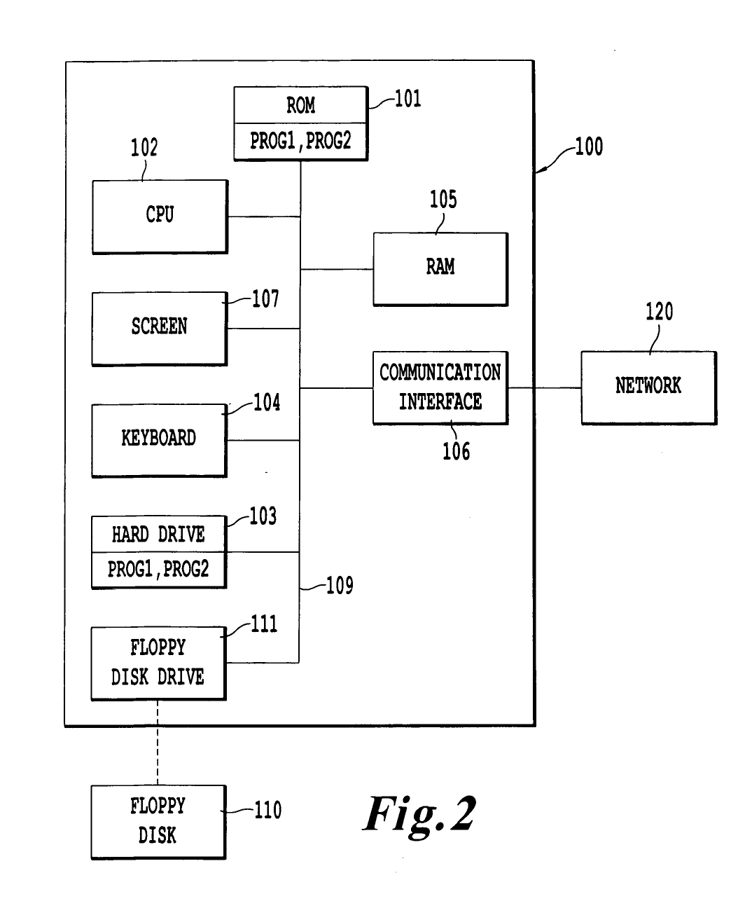

With reference to FIG. 2, there are represented the physical resources of a programmable machine 100 capable of implementing the invention.

Machine 100 is provided with a communications bus 109, to which there are connected:

a central processing unit (microprocessor or CPU) 102, which controls the exchanges between the various elements of the machine;

a read-only memory (ROM) 101, which can be provided with the inventive programs (Prog1, Prog2);

a random-access memory (RAM) 105;

a hard disk 103, which can be provided with the aforesaid programs;

a keyboard 104;

a screen 107;

a floppy disk drive 111 capable of receiving a floppy disk 110 and reading therefrom or writing thereto documents that have been processed or that are to be processed according to the invention;

a communications interface 106 connected to a communications network 120, such as the Internet, the interface being capable of transmitting and receiving documents.

Communications bus 109 permits communication and interoperability between the different elements included in the machine or connected thereto. The representation of the bus is not limitative and, in particular, the central unit is capable of communicating instructions to any element of the machine directly or by the agency of another element of the machine.

The executable code of each program that permits the programmable machine to implement the processing operations according to the invention can be stored, for example, on hard disk 103 or in read-only memory 101.

According to an alternative embodiment, floppy disk 110 can contain documents as well as the executable code of the aforesaid programs, which code, once read by the machine, is stored on hard disk 103.

According to another alternative embodiment, the executable code of the programs can be received by the agency of the communications network, via interface 106, in order to be stored in a manner identical to that described in the foregoing.

The floppy disks can be replaced by any information medium such as a compact disk (CD ROM) or a memory card. In general, an information storage means that is visible to a computer or microprocessor, that may or may not be integrated into the machine and that may or may not be removable is suitable for storage in memory of one or more programs that can be run to permit implementation of the method according to the invention.

More generally, the program or programs can be loaded into one of the storage means of the machine before being run.

Central unit 102 controls and directs the execution of instructions or of portions of the software code of the program or programs according to the invention, which instructions are stored in hard disk 103 or read only memory 101, or else in the other storage elements cited in the foregoing. During boot up, the program or programs that are stored in a non-volatile memory, such as hard disk 103 or memory ROM 101, are transferred into random access memory RAM 105, which will then contain the executable code of the program or programs according to the invention, as well as the registers for storage in memory of the variables of the parameters necessary for implementation of the invention.

It is appropriate to note that the programmable machine containing the device according to the invention can also be a programmed machine.

This machine then contains the code of the information program or programs, which may be resident, for example, in an application-specific integrated circuit (ASIC).

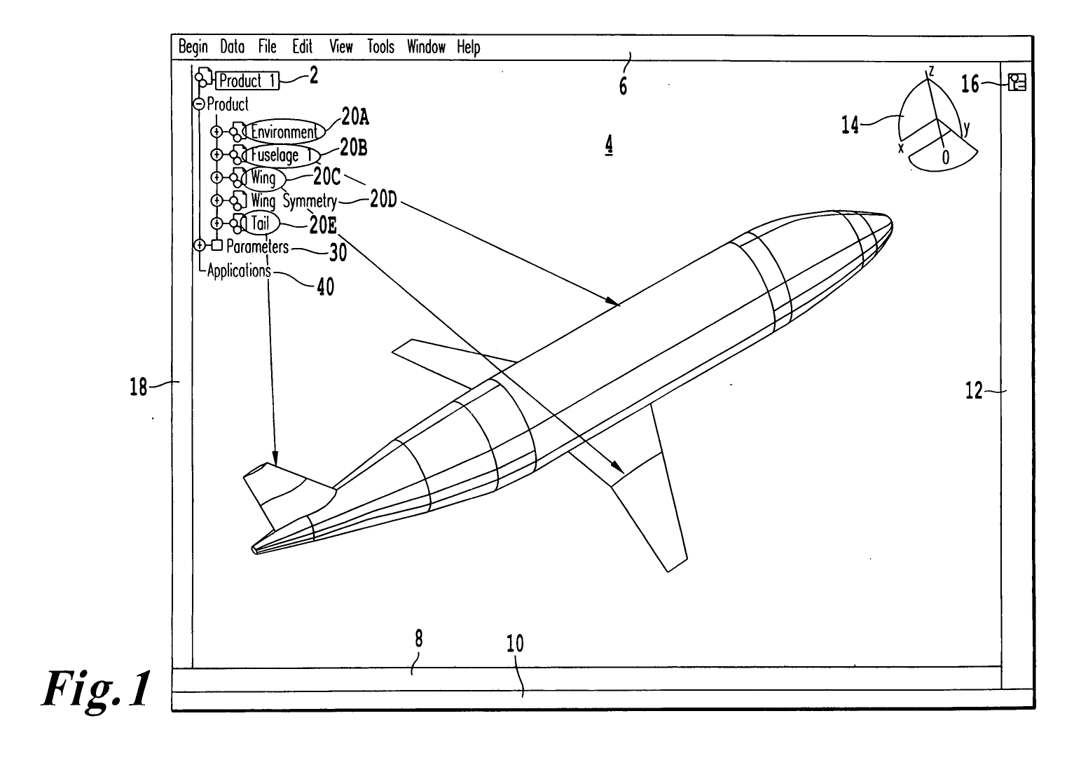

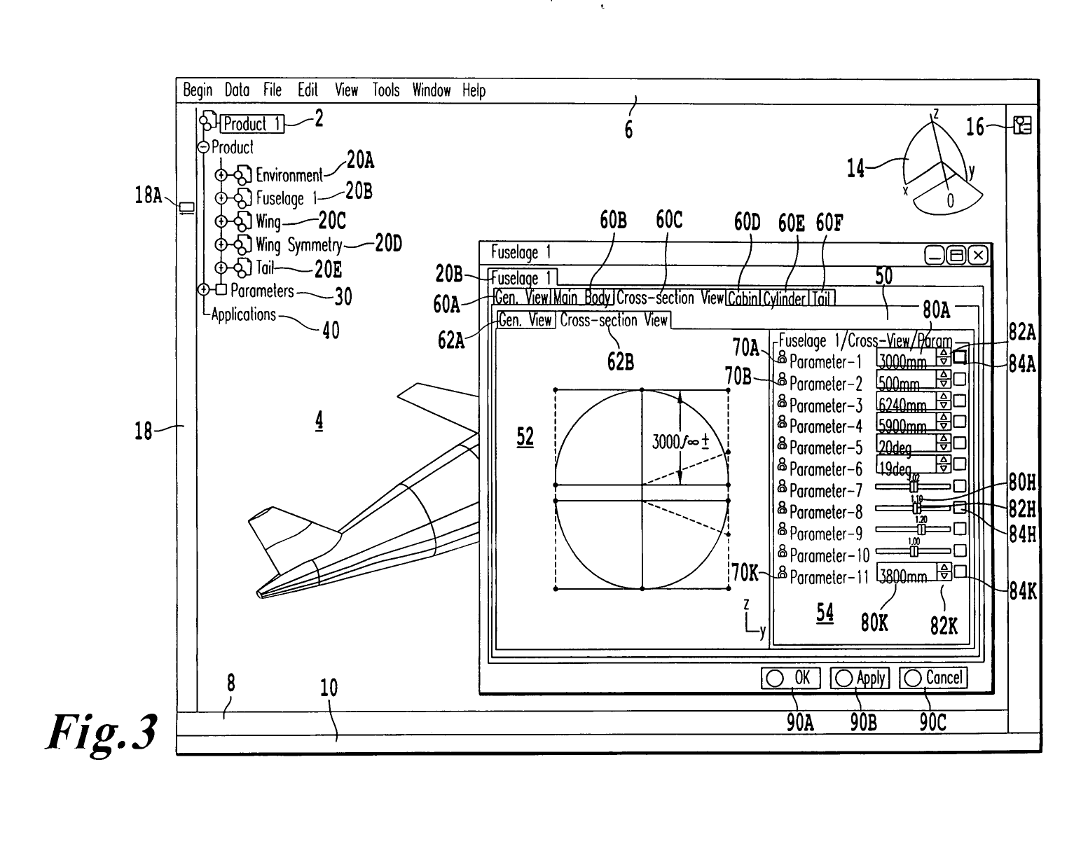

With reference to FIG. 3, there is represented the working environment of the 3D digital mockup of the aircraft of FIG. 1. Specifications tree 2 and the graphical representation 4 of the aircraft are also shown.

Upon selection of one of the active elements of the specifications tree 2, in this case the “fuselage.1” element 20B, and upon activation of the “edit parameters” button or icon 18A situated in toolbar 18, a second graphical interface 50 appears on the microcomputer screen, where it is superposed on first graphical interface 4.

This graphical interface 50 is a dialog box provided with at least one part 54 relating to the control parameters and, as the case may be, with a part 52 relating to the geometry of the corresponding element. Graphical interface 50 comprises a tab 60 for each element of the “fuselage.1” model 20B. Tabs 60 are subdivided into 60A to 60F, for the elements designated as “general view”, “principal member”, “cross section”, “cockpit”, “cylinder” and “tail” respectively.

In part 54 there is found a list of control parameters 70 associated with the selected tab, in this case tab 60C corresponding to the “cross section”.

Parameters 70 are subdivided into 70A to 70K. With each parameter 70 there is associated a field 80, the value of which can be modified by the user with the help of means for varying the values, such as a scroll bar 82A or a cursor 82H. Each parameter also comprises a selection button 84.

Icon 18A is a shortcut via which the control that displays dialog box 50 according to the invention can be launched. This control generates a parameter editor that represents the model in structured and functional manner without depending directly on the construction history of the component or on the specification tree. The parameter editor presents individual fields 80 intended for editing at least some of the parameters 70 of the model. Fields 80 are directly associated with the parameters of the model.

Graphical interface 50 is supplemented by three validation buttons, designated as “OK” 90A, “Apply” 90B and “Cancel” 90C.

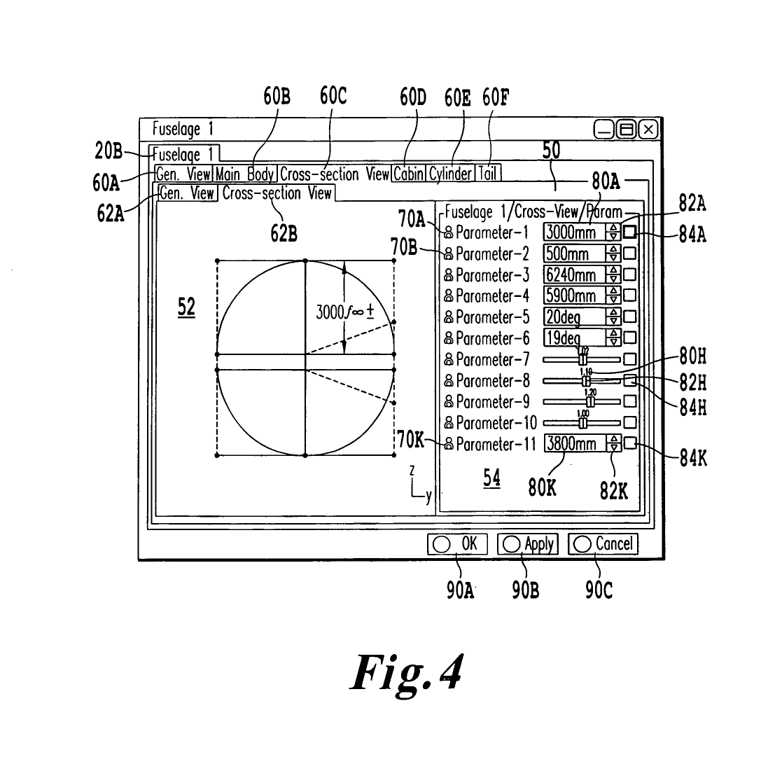

With reference to FIG. 4, the user selects, in part 54 of dialog box 50, the parameter that he wishes to process, modify and/or view in part 52 of box 50. In the present case, the user selects parameter 70A corresponding to the height of the fuselage in cross section. The original value entered in associated field 80A is 3000 mm in this case. The user views the part of the geometry that is affected by parameter 70A in part 52 of the dialog box.

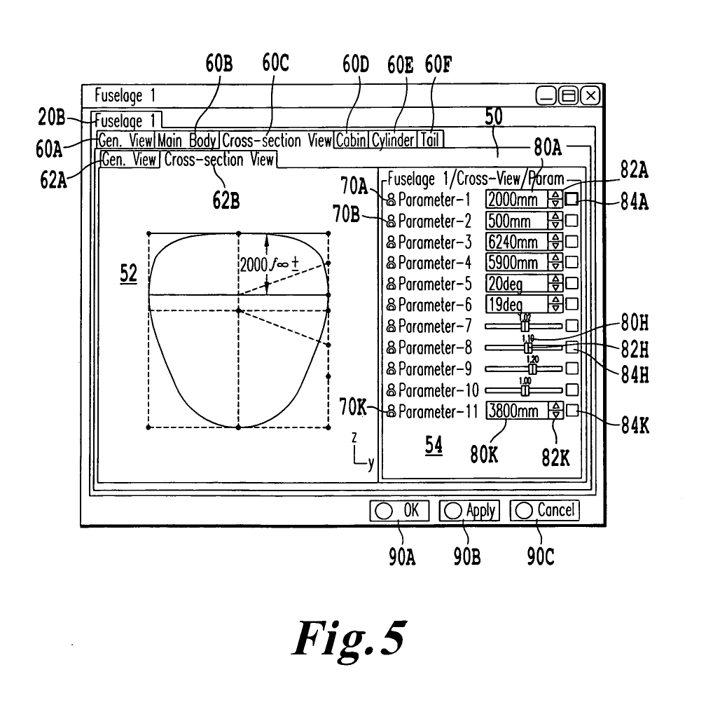

With reference to FIG. 5, the user wishes to modify the value of the adjustment of parameter 70A compared with the value indicated in FIG. 4. In the present example, he uses scroll bar 82A to modify the value of the height (new value=2000 mm) of the parameter 70A with regard to the cross section of the fuselage. The effect of the change in the value of the parameter is shown substantially in real time (1 to 2 seconds) in graphical window 52.

Selection of validation button 90A (OK) makes it possible automatically to incorporate the new value of the parameter in the set of elements of the product.

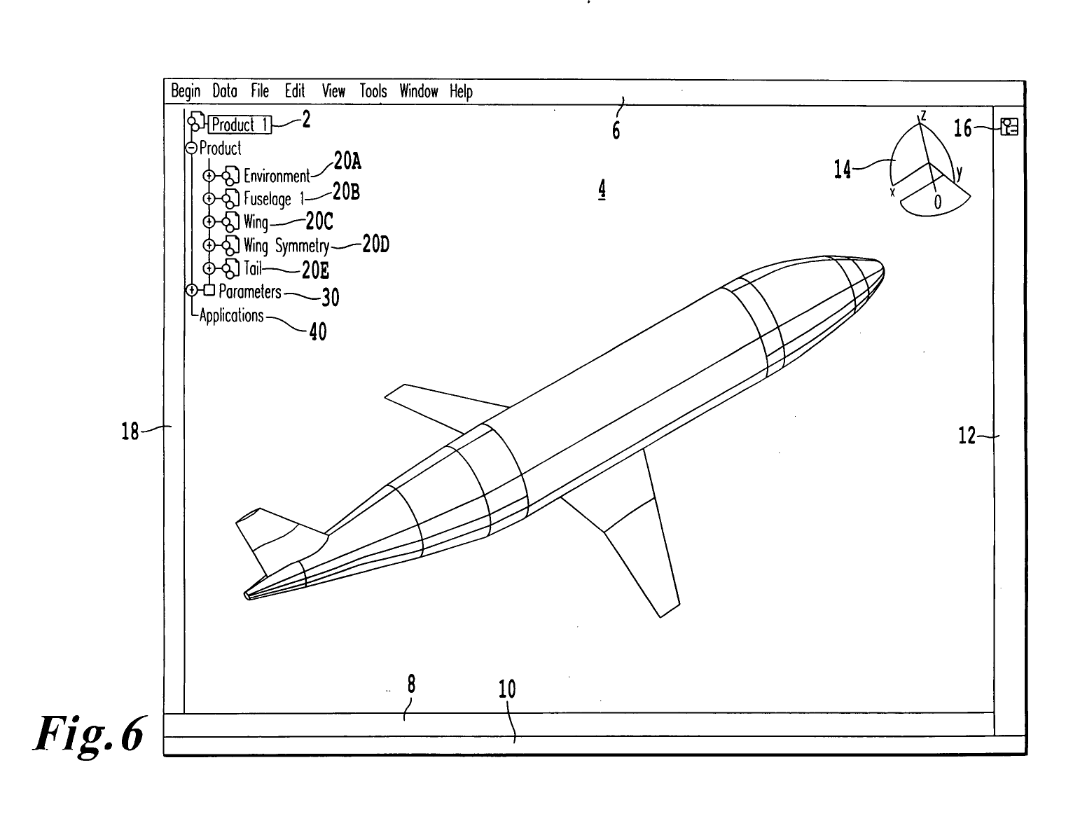

With reference to FIG. 6, it is observed substantially automatically that the change in the value of parameter 70A with the help of box 50 as described with reference to FIG. 5 brings about a corresponding modification in specifications tree 2 and in the geometry (in this case a reduction of the cross section of the fuselage) displayed in graphical interface 4, compared with working environment 2 and 4 described with reference to FIG. 1.

In practice, it is a converter that transforms specifications tree 2 into a graphical user interface 50, 52, 54 in which, for at least one active element, in this case active element 20B of the said tree 2 with reference to FIGS. 2 to 6, there is associated a dialog box comprising at least one field 80A associated with at least one control parameter 70A of the said active element. In practice, the converter according to the invention generates a structured parameter editor that presents fields that can be parameterized by the non-specialist user in a functional approach close to the specialized problem associated with the design of the component.

The adjustment of control parameters 70A can be modified by a non-specialist user of the CAD software by selecting icon 1 8A, which launches the parameter editor according to the invention. In practice, the parameter editor is based on native parameter-editing functions available in the CAD software.

According to the invention, the parameter editor organizes and structures the parameters of the model in dialog box 50 with the help of the said native functions.

Each adjustment of the said control parameter is displayed visually in the corresponding field 80, and it automatically brings about the change of adjustment of the control parameter of the corresponding active element in specifications tree 2. Thus a user can modify the value of a parameter easily and directly via the dialog box.

Graphical window 52 contains the geometry of the corresponding active element 20B, the adjustment of the said parameter being displayed in the said graphical window 52, thus permitting the non-specialist user to verify visually the effect of the modification of the value of the parameter.

In practice, the converter transforms each active element into a dialog box according to the chosen editing and conversion rules.

For example, each element 20A, 20B, 20C, 20D, 20E of specifications tree 2 belongs to the group formed by terminal nodes and non-terminal nodes. With each terminal node there are associated a visual display 52 of graphical user window type and a parameter editor 1 8A. With each non-terminal node there are associated a parameter editor 1 8A and a plurality of tabs 60, a sub-node 62 being associated with each tab 60.

In practice, the parameter editor is additionally a script editor, for example, the script language is a markup language of the XML type.

Thus, by virtue of communications interface 106, it is possible to exchange the values of parameterizable fields 80 remotely, in-the form of XML files. Such an exchange makes it possible to work in collaboration remotely with other users by exchanging small files containing the modifications of parameters exclusively in the form of texts or scripts.

In practice, the converter has the form of a series of supplementary software functionalities added to the CAD software by what is known as an “add on” extension mechanism. This extension is composed physically of a series of dynamic libraries and resource files that can have the form of a text file, icons or CAD software files.

The editing rules can distinguish two categories of control parameters: the modifiable parameters and the non-modifiable parameters.

The conversion software according to the invention is launched by opening a 3D model already created by the CAD software, such as Catia Version V5. The conversion software will make it possible to modify the parameters of the 3D model easily and directly without needing in-depth understanding of the CAD software and without causing a modification of the source code.

What is claimed as new and desired to be secured by letters:

1. A device for generation of a parametric model associated with a 3D geometry of a component or of an assembly of components, said model being represented graphically on a computer screen in the form of a specifications tree comprising at least one element defined by at least one control parameter, said device comprising:
a converter capable of converting said specifications tree into a graphical user interface in which, for at least one active element of said tree, there is associated a dialog box comprising at least one field associated with at least one control parameter of said active element, the adjustment of said control parameter being modifiable by the user with the help of a parameter editor, each adjustment of said control parameter being displayed in the corresponding field of the dialog box and automatically bringing about the change of the adjustment of the control parameter of the corresponding active element in the specifications tree.

2. A device according to claim 1, wherein the graphical interface additionally comprises a graphical window containing the geometry of the corresponding active element, the adjustment of said parameter being displayed visually in said graphical window.

3. A device according to claim 1, wherein each element of the specifications tree belongs to the group formed by terminal nodes and non-terminal nodes.

4. A device according to claim 3, wherein a visual display function of the graphical user window type and a parameter editor are associated with each terminal node.

5. A device according to claim 3, wherein a parameter editor and a plurality of tabs are associated with each non-terminal node, a sub-node being associated with each tab.

6. A device according to claim 5, wherein a graphical window is associated with at least certain tabs.

7. A device according to claim 1, wherein the parameter editor is additionally a script editor.

8. A device according to claim 7, wherein the script language is a markup language of the XML type.

9. A device according to claim 1, further comprising a communications device capable of remote exchange of values of parameterizable fields for the purpose of making it possible to work in collaboration remotely together with other users.

10. A method for generation of a parametric model associated with a 3D geometry of a component or of an assembly of components, said model being represented graphically on a computer screen in the form of a specifications tree comprising at least one element defined by at least one control parameter, the method comprising the following steps:
transforming said specifications tree into a graphical user interface in which, for at least one active element of the said tree, there is associated a dialog box comprising at least one field associated with at least one control parameter of the said active element,
modifying the adjustment of said control parameter by the user with the help of a parameter editor,
displaying each adjustment of said control parameter in the corresponding field of the dialog box, and
automatically changing the adjustment of the control parameter of the corresponding active element in the specifications tree.

11. A method according to claim 10, further comprising the step of displaying the adjustment of said parameter visually in a graphical window.

12. A method according to claim 10 or claim 11, wherein the values of parameterizable fields are remotely exchanged in the form of scripts or text files.

13. An information medium that can be read by an information-processing system, said medium including instructions of an information-processing program permitting the use of the generation method according to claim 10, when said program is loaded and run by an information-processing system.

14. A removable information medium that can be read partly or totally by an information-processing system, said medium including instructions of an information-processing program permitting the use of the generation method according to claim 10, when said program is loaded and run by an information-processing system.

15. A computer program stored on an information medium, said program being composed of instructions permitting the use of a generation method according to claim 10, when said program is loaded and run by an information-processing system.
